(19) United States
(12) Patent Application Publication
(10) Pub. No.: US 2009/0055483 A1
(43) Pub. Date: Feb. 26, 2009

(54) Enhanced Collaboration in Instant Messaging

(76) Inventors: Rooma Madan, Raleigh, NC (US); Sahdev P. Zala, Cary, NC (US); Bimal Shah, Cary, NC (US)

Correspondence Address: HAMILTON & TERRILE, LLP;IBM RSW, P.O. BOX 203518, AUSTIN, TX, 78720, US

(21) Appl. No.: 11/841,100

(22) Filed: Aug. 20, 2007

(51) Int. Cl. G06F 15/16

(52) U.S. Cl. 709/206

(57) ABSTRACT

A method, system and computer-usable medium for providing synchronous, real-time collaboration in an instant messaging system (IMS). A shared workspace is created on the IMS, accessible by IMS users through a collaboration window implemented on their respective IMS clients. Predetermined digital content is entered into the shared workspace by an IMS initiating user. Modification operations are then synchronously performed in real-time on the digital content by one or more IMS modifying users within their respective collaboration windows. Modification operations performed by a first IMS modifying user block a second IMS modifying user from performing their own modification operations until the first IMS modifying user relinquishes control. Predetermined visual attributes are assigned to each IMS modifying user to visually track the modifications they make.

### BACKGROUND OF THE INVENTION

1. Field of the Invention

Embodiments of the disclosure relate in general to the field of computers and similar technologies, and in particular to software utilized in this field. Still more particularly, it relates to providing synchronous, real-time collaboration in an instant messaging system.

2. Description of the Related Art

The ability to collaborate in real-time, regardless of an individual's physical location or time zone, has become increasingly important for businesses, educational institutions, and organizations of all types. To be effective, collaboration requires simultaneous communication between individuals. In the past, this meant that collaborators needed to be face-to-face. However, it is often difficult for everyone who needs to participate in a collaboration session to gather together in a single location. As a result, telephone and video conferencing are often used as a supplement, or as an alternative, to physical meetings. More recently, groupware such as electronic whiteboards, electronic mail (email) and instant messaging have also proven to be useful means for enabling effective collaboration.

In general, these collaboration software applications fall into two broad classifications—asynchronous and synchronous. Examples of software for asynchronous collaboration include email applications such as the Lotus Notes and Microsoft Exchange email applications. These, along with on-line discussion groups where data is exchanged in non-real-time do not support concurrent collaboration. In contrast, software for synchronous collaboration is designed to support real-time interaction between collaborators and includes concurrent whiteboards, chat rooms, and instant messaging applications.

However, each of these has attendant issues that limit their effectiveness in supporting real-time collaboration. For example, the use of email results in a large trail, or thread, of messages as a collaborative project advances. In addition, these messages have no common repository that can be instantaneously and simultaneously accessed by all team members. Furthermore, individual collaborators often enter a thread at different points, which is inefficient when attempting to coordinate the efforts of a team comprising many members. Conversely, synchronous collaboration tools such as electronic whiteboards typically allow users to publish documents or files to a common workspace. Once published, they can be concurrently edited in real-time, simultaneously with in-line discussions between the collaborators. However, the learning curve for such applications can be steep and their computing and network overhead may unnecessarily tax available resources when used for simple collaborative efforts, such as editing a paragraph of text. In contrast, synchronous collaboration applications such as chat and instant messaging are simple to use, lightweight, and typically operate on text files. While they would appear to be a candidate for simple collaborative operations, they currently do not provide a shared workspace that can be simultaneously seen and edited by the collaborators.

### BRIEF SUMMARY OF THE INVENTION

The present invention includes, but is not limited to, a method, system and computer-usable medium for providing synchronous, real-time collaboration in an instant messaging system (IMS). In various embodiments of the invention, an IMS session is established between IMS users, with IMS session messages being presented to the IMS users within a message window of an IMS client user interface (UI). A shared workspace is created on the IMS, accessible by the IMS users through a collaboration window implemented on the UI of their respective IMS clients. Predetermined digital content is entered into the shared workspace through the collaboration window by an IMS initiating user.

Modification operations are then synchronously performed in real-time on the digital content by one or more IMS modifying users within the collaboration window of their respective IMS clients. Modification operations performed by a first IMS modifying user block a second IMS modifying user from performing modification operations until the first IMS modifying user relinquishes control to the next IMS modifying user. A predetermined visual attribute, such as a text color or a user icon, is assigned to each IMS modifying user. The visual attribute is then applied to the results of the modification operations they performed allowing the other IMS users to determine which IMS modifying user made which modification. In one embodiment, the modified digital content is stored in a predetermined repository for subsequent retrieval. In another embodiment, the modified digital content is exported from the shared workspace to the message window of each IMS user's IMS client. The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 is a simplified block diagram of an instant messaging system (IMS) collaboration system as implemented in accordance with an embodiment of the invention;

FIGS. 3a-3b are a generalized flow chart showing an IMS collaboration system as implemented in accordance with an embodiment of the invention;

FIG. 4 shows a simplified user interface (UI) of an IMS collaboration system as implemented to modify digital content within a collaboration window in accordance with an embodiment of the invention; and

FIG. 5 shows a simplified UI of an IMS collaboration system as implemented to display modified digital content within a collaboration window in accordance with an embodiment of the invention.

### DETAILED DESCRIPTION

A method, system and computer-usable medium are disclosed for providing synchronous, real-time collaboration in an instant messaging system (IMS). As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit”, “module”, or “system”. Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therein, either in base band or as part of a carrier wave. The computer usable program code may be transmitted using any appropriate medium, including but not limited to the Internet, wire line, optical fiber cable, and radio frequency (RF), etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

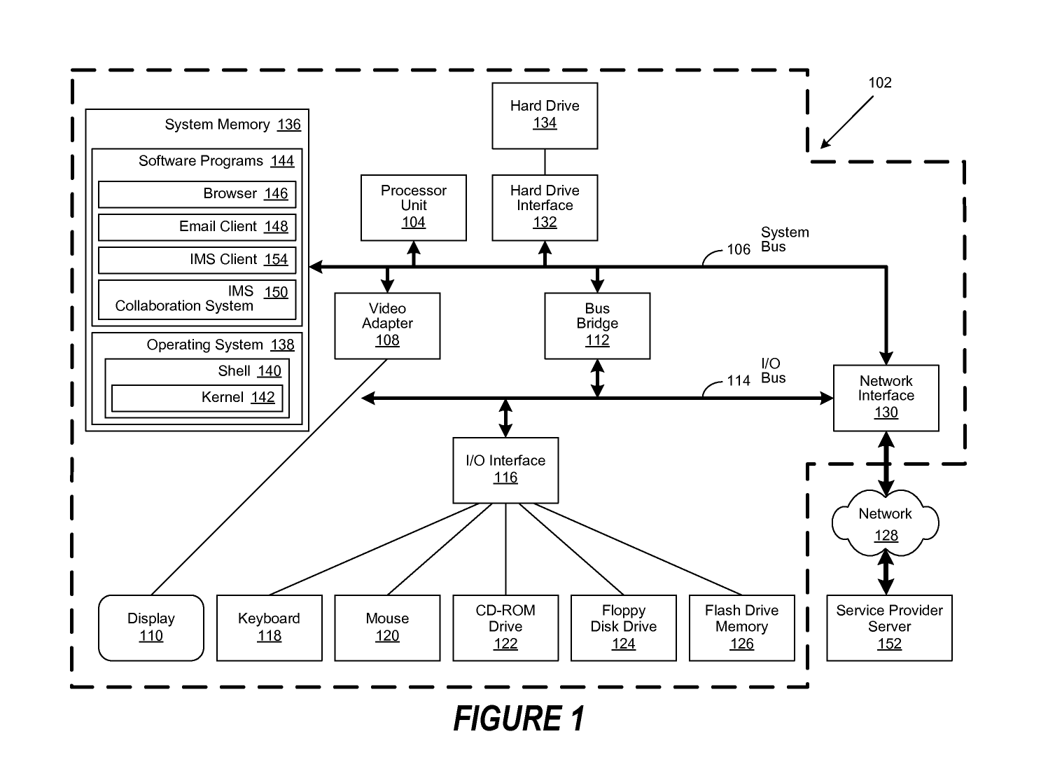

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management.

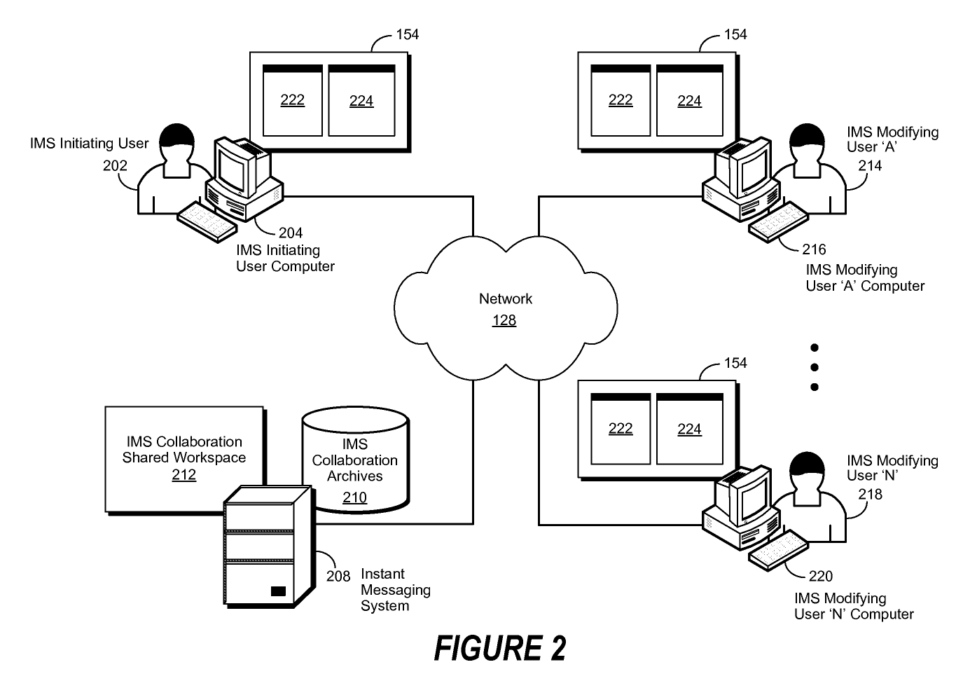

Software programs 144 may include a browser 146, email client 148, and instant messaging system (IMS) client 154. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. Software programs 144 also include an IMS collaboration system 150. IMS collaboration system 150 includes code for implementing the processes described in FIGS. 2 through 5 described hereinbelow. In one embodiment, client computer 102 is able to download IMS collaboration system 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 is a simplified block diagram of an instant messaging system (IMS) collaboration system as implemented in accordance with an embodiment of the invention. In various embodiments, IMS initiating user computer 204 and IMS editing user computers ‘A’ 216 through ‘N’ 220 are connected to instant messaging system 208 over network 128. IMS collaboration operations are begun by first initiating an IMS session between IMS initiating user 202 and IMS modifying users ‘A’ 214 through ‘N’ 218 on instant messaging system 208. Once the IMS session is initiated, IMS session operations are performed within the IMS message window 222 of each IMS user's IMS client 154.

The IMS initiating user 202 then launches a collaboration window 224 within the user interface (UI) of the IMS client 154 running on the IMS initiating user computer 204. In one embodiment, the collaboration window 224 is launched through a user gesture, such as a mouse click on a collaboration icon within the IMS client 154. By launching the collaboration window 224, an IMS collaboration shared workspace 212 is created on instant messaging system 208. The IMS initiating user 202 then assigns each of the IMS modifying users ‘A’ 214 through ‘N’ 218 a visual attribute, such as a text color or a user icon, to track their actions within the launched collaboration window 224. Once the collaboration window 224 is launched by the IMS initiating user 202, a collaboration window 224 is likewise automatically launched in the UI of each IMS client 154 of IMS modifying users ‘A’ 214 through ‘N’ 218. As a result, IMS modifying users ‘A’ 214 through ‘N’ 218 are provided concurrent, real-time access to the IMS collaboration shared workspace 212 through their respective collaboration windows 224.

The IMS initiating user 202 then enters digital content into the collaboration window 224 of their IMS client 154. Once the digital content is entered into the collaboration window 224 of their IMS client 154, the IMS initiating user 202 relinquishes modification control to a first IMS modifying user ‘A’ 214 through ‘N’ 218. The first modifying user ‘A’ 214 through ‘N’ 218 then performs modification operations on the digital content currently within the collaboration window 224 of their respective IMS client 154. The visual attributes of the first IMS modifying user ‘A’ 214 through ‘N’ 218 are applied to the results of the modification operations, which are viewable in real-time within the collaboration window 224 of each IMS user's IMS client 154. In parallel with the modification operations, IMS session operations continue concurrently within each IMS user's message window 222 of their respective IMS client 154.

Once the current IMS modifying user ‘A’ 214 through ‘N’ 218 has completed their modification operations, control of the collaboration window 224 is relinquished to the next IMS modifying user ‘A’ 214 through ‘N’ 218. In one embodiment, the current IMS modifying user ‘A’ 214 through ‘N’ 218 signifies that they have completed their modification operations within the collaboration window 224 through a user gesture, such as clicking on an “Apply Modifications” button. The modifications are applied concurrently, in real-time, to the content displayed within the collaboration window 224 of each IMS user's IMS client 154. Once applied, the other IMS users 202, 214, 218 are notified that the collaboration window 224 is now available for use by the next IMS modifying user ‘A’ 214 through ‘N’ 218. Once modification operations are completed, the current IMS modifying user ‘A’ 214 through ‘N’ 218 saves the modified digital content. In one embodiment, the modified digital content is archived to a repository 210 for subsequent retrieval by the IMS users 202, 214, 218 that collaborated in the IMS session. Once saved, the modified content is transferred by the current modifying user ‘A’ 214 through ‘N’ 218 from the collaboration window 224 into the message window 222 of each IMS user's IMS client 154. The current modifying user ‘A’ 214 through ‘N’ 218 then closes the collaboration window 224 in their IMS client 154, signifying to the other IMS users 202, 214, 218 that modification operations have concluded. The other IMS users 202, 214, 218 then close the collaboration window 224 in their respective IMS clients 154.

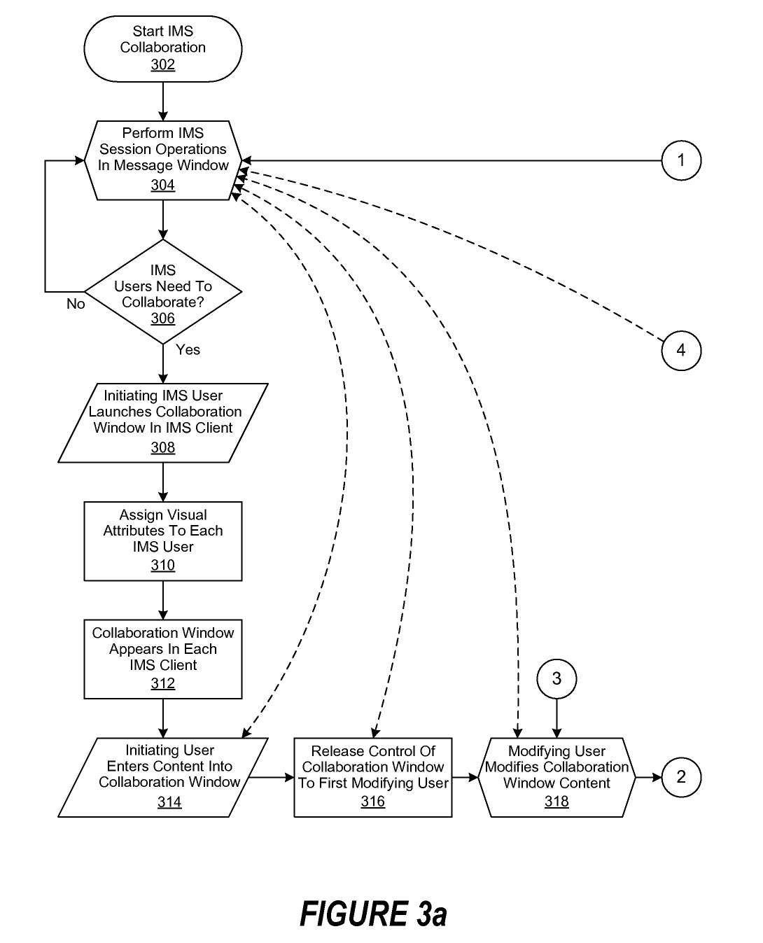

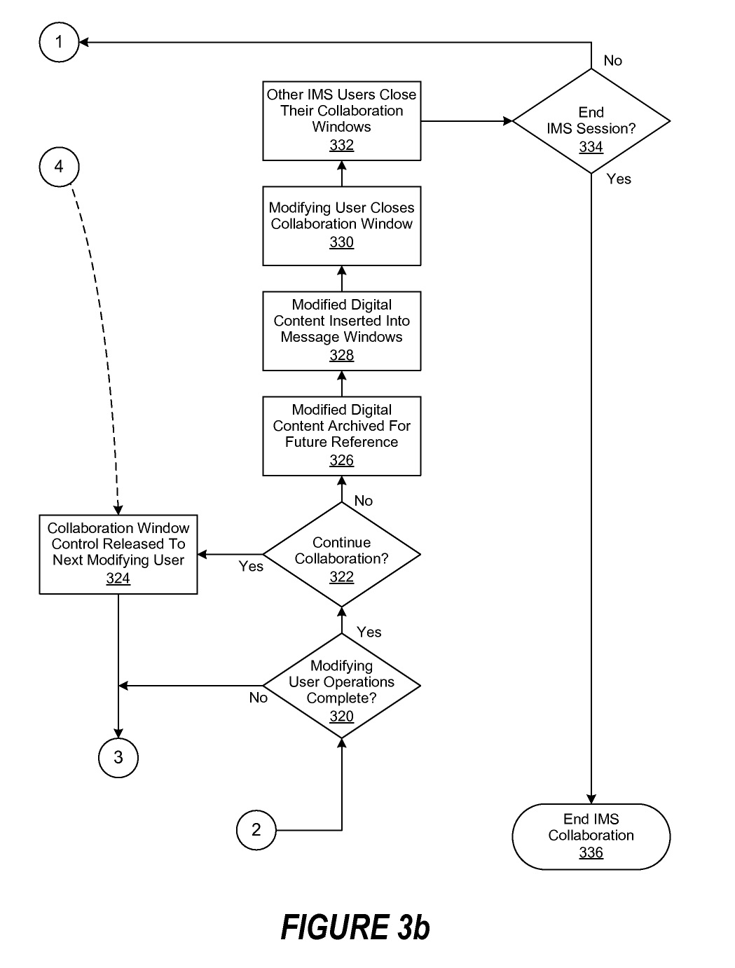

FIGS. 3a-b are a generalized flow chart showing an instant messaging system (IMS) collaboration system as implemented in accordance with an embodiment of the invention. In this embodiment, IMS collaboration operations are begun in step 302 by first initiating an IMS session between a plurality of IMS users. Once the IMS session is established, IMS session operations are performed within the IMS message window of each IMS user's IMS client in step 304. A determination is then made in step 306 whether or not the plurality of IMS users need to collaborate. If it is determined that they do not, then the IMS session operations continue, beginning with step 304. Otherwise, one of the IMS users initiates collaboration operations in step 308 by launching a collaboration window within the user interface (UI) of their IMS client. In one embodiment, the collaboration window is launched through a user gesture of the initiating user, such as a mouse click on a collaboration icon within their IMS client. In step 310, the IMS initiating user assigns each of the other IMS users a visual attribute, such as a text color or a user icon, to track their actions within the launched collaboration window. Once the collaboration window is launched by the IMS initiating user, a collaboration window is likewise automatically launched in the UI of each IMS user's IMS client in step 312.

The IMS initiating user then enters digital content into the collaboration window of their IMS client in step 314. For example, the IMS initiating user may enter a body of text into the collaboration window for collaborative review and modification. Meanwhile, IMS session operations continue concurrently within each IMS user's message window in step 304. Once the digital content is entered into the collaboration window, the IMS initiating user relinquishes modification control to a first IMS modifying user in step 316. Meanwhile, IMS session operations continue concurrently within each IMS user's message window in step 304. The first modifying user then performs modification operations in step 318 on the digital content currently within the collaboration window. The visual attributes of the first IMS modifying user are applied to the results of the modification operations, which are viewable in real-time within the collaboration window of each IMS user's IMS client. Meanwhile, IMS session operations continue concurrently within each IMS user's message window in step 304.

A determination is then made in step 320 whether the current IMS modifying user has completed their modification operations. If they have not, then the process continues, beginning with step 318 and IMS session operations continue concurrently within each IMS user's message window in step 304. Otherwise, a determination is made in step 322 if collaboration operations are to continue. If they are, then control of the collaboration window is relinquished by the current IMS modifying user in step 324. In one embodiment, the IMS modifying user signifies that they have completed their modification operations within the collaboration window through a user gesture, such as clicking on an “Apply Modifications” button. The modifications are applied concurrently, in real-time, to the content displayed within the collaboration window of each IMS user's IMS client. Once applied, the other IMS users are notified that the collaboration window is now available for use by the next IMS modifying user. For example, a red hourglass icon may indicate that digital content in the collaboration window is currently being modified by another IMS user. Conversely, a green light icon may indicate that the digital content in the collaboration window is currently available for modification by other IMS users. Once control of the collaboration window is released in step 324 by the current IMS modifying user, the process continues, beginning with step 318. Meanwhile, IMS session operations continue concurrently within each IMS user's message window in step 304.

Otherwise, the current IMS modifying user saves the modified digital content in step 326. In one embodiment, the modified digital content is archived to a repository for subsequent retrieval by the IMS users that collaborated in the IMS session. Once saved, the modified content is transferred by the current modifying user from the collaboration window into the message window of each IMS user's IMS client. In step 330, the current modifying user closes the collaboration window in their IMS client, signifying to the other IMS users that modification operations have concluded. The other IMS users then close the collaboration window in their respective IMS clients in step 332. A determination is then made in step 334 whether or not to end the IMS session. If not, then IMS session operations continue concurrently within each IMS user's message window, beginning in step 304. Otherwise, IMS collaboration is ended in step 336.

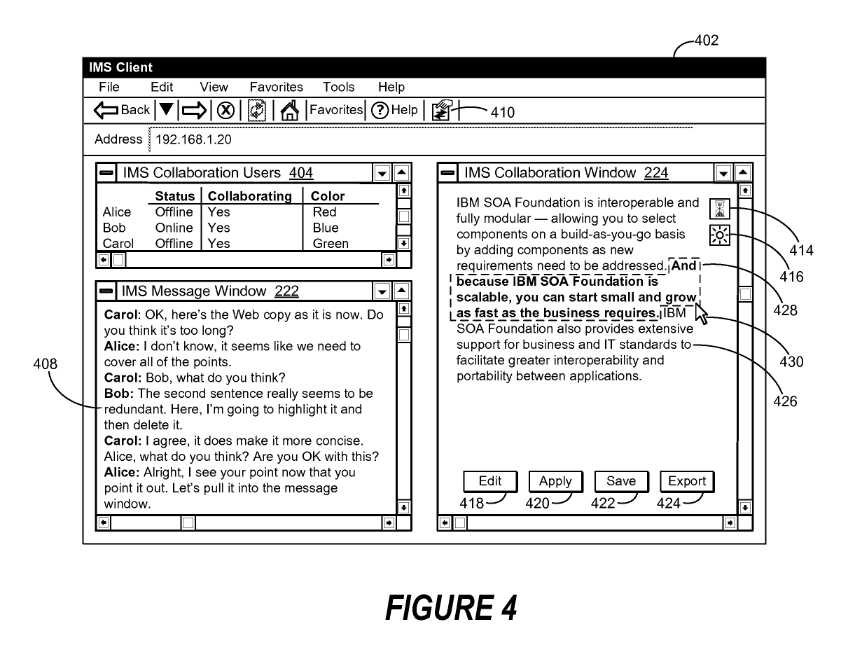

FIG. 4 shows a simplified user interface (UI) of an IMS collaboration system as implemented to modify digital content within a collaboration window in accordance with an embodiment of the invention. In this embodiment, IMS client UI 402 comprises IMS collaboration users window 404, IMS message window 222, IMS collaboration window 224, and IMS collaboration icon 410. IMS message window 222 further comprises the results 408 of IMS session operations, such as message exchanges between IMS users. IMS collaboration window 224 further comprises control buttons “Edit” 418, “Apply” 420, “Save” 422, “Export” 424 and collaboration status indicators 414 and 416. In this and other embodiments, IMS collaboration operations are begun by first initiating an IMS session between an IMS initiating user and one or more IMS modifying users. Once the IMS session is initiated, IMS session operations are performed within the IMS message window 222.

The IMS initiating user then launches a collaboration window 224. In one embodiment, the collaboration window 224 is launched through a user gesture, such as a mouse click on the collaboration icon 410. By launching the collaboration window 224, the IMS initiating user initiates an IMS collaboration shared workspace on an instant messaging system. The IMS initiating user then assigns each IMS user a visual attribute, such as a text color or a user icon, in the IMS collaboration user window 404 to track their actions within the launched collaboration window 224. Once the collaboration window 224 is launched by the IMS initiating user, a similar collaboration window 224 is automatically launched in each IMS user's IMS client UI 402. As a result, all IMS users are provided concurrent, real-time access to the IMS collaboration shared workspace through their respective collaboration windows 224.

The IMS initiating user then enters digital content 426 into the collaboration window 224. Once the digital content 426 is entered into the collaboration window 224, the IMS initiating user relinquishes modification control to a first IMS modifying user. The first modifying user then performs modification operations on the digital content 426 currently within the collaboration window 224 of their respective IMS client UI 402. For example, cursor 430 may be used to select a section 428 of the digital content 426. Once selected, the visual attributes of the first IMS modifying user are applied to the selected text 428. As a result, the applied attributes are viewable in real-time within the collaboration window 224 of each IMS user's IMS client UI 402. In parallel with the modification operations, IMS session operations continue concurrently within each IMS user's message window 222 of their respective IMS client UI 402.

Once the current IMS modifying user has completed their modification operations, control of the collaboration window 224 is relinquished to the next IMS modifying user. In one embodiment, the current IMS modifying user signifies that they have completed their modification operations within the collaboration window 224 through a user gesture, such as clicking on an “Apply Modifications” button 420. The modifications are applied concurrently, in real-time, to the content displayed within the collaboration window 224 of each IMS user's IMS client UI 402. Once applied, the other IMS users are notified that the collaboration window 224 is now available for use by the next IMS modifying user. For example, a red hourglass icon 414 may indicate that digital content in the collaboration window is currently being modified by another IMS user. Conversely, a green light icon 416 may indicate that the digital content in the collaboration window is currently available for modification by other IMS users.

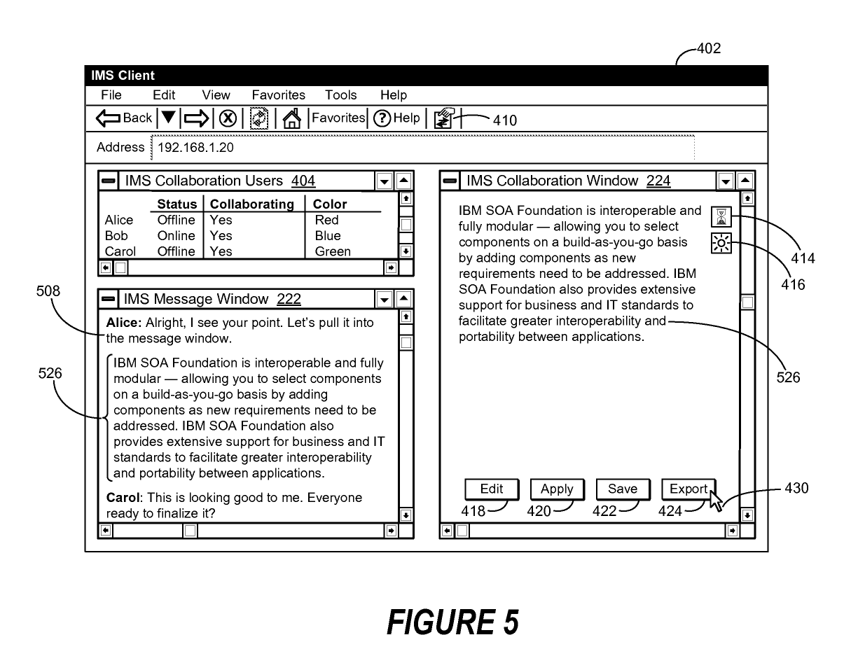

FIG. 5 shows a simplified user interface (UI) of an IMS collaboration system as implemented to display modified digital content within a collaboration window in accordance with an embodiment of the invention. In this embodiment, IMS client UI 402 comprises IMS collaboration users window 404, IMS message window 222, IMS collaboration window 224, and IMS collaboration icon 410. IMS message window 222 further comprises the prior results 508 of IMS session operations, such as message exchanges between IMS users. IMS collaboration window 224 further comprises control buttons “Edit” 418, “Apply” 420, “Save” 422, “Export” 424 and collaboration status indicators 414 and 416.

Once the collaboration window 224 is launched by the IMS initiating user, a similar collaboration window 224 is automatically launched in each IMS user's IMS client UI 402. As a result, all IMS users are provided concurrent, real-time access to the IMS collaboration shared workspace through their respective collaboration windows 224. The IMS initiating user then enters digital content 426 into the collaboration window 224. Once the digital content 426 is entered into the collaboration window 224, modification operations are performed as described in greater detail herein. When modification operations are completed, the current IMS modifying user saves the modified digital content 526 through a user gesture, such as clicking on “Save” button 422.

In one embodiment, the modified digital content is archived to a repository for subsequent retrieval by the IMS users that collaborated in the IMS session. Once saved, the modified content 526 is transferred by the current modifying user from the collaboration window 224 into the message window 222 of each IMS user's IMS client UI 402. In another embodiment, the modified text 526 is exported to the IMS message window 222 through a user gesture such as clicking on the “Export” button 424. The current modifying user then closes the collaboration window 224 in their IMS client UI 402, signifying to the other IMS users that modification operations have concluded. The other IMS users then close the collaboration window 224 in their respective IMS client UI 402.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of skill in the art without departing from the scope and spirit of the invention. The embodiment was chosen and described in order to best explain the principles of the invention and the practical application, and to enable others of skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for providing synchronous, real-time collaboration in an instant messaging system (IMS), comprising:
establishing an IMS session between a plurality of IMS users, the IMS session being presented to the plurality of IMS users in a first window of an IMS user interface (UI);
generating a shared workspace, accessible by the plurality of the IMS users through a second window of the IMS UI;
enabling digital content to be entered into the shared workspace through the second window by an IMS initiating user; and
enabling modification operations on the digital content to be performed via the second window, the modification operations being synchronously performable by a plurality of IMS modifying users.

2. The method of claim 1, wherein the shared workspace resides in the IMS.

3. The method of claim 1, wherein
the modification operations performed by a first IMS modifying user block a second IMS modifying user from performing modification operations until the first IMS modifying user relinquishes control of the modification operations to the second IMS modifying user.

4. The method of claim 1, wherein
a visual attribute is assigned to each of the plurality of IMS modifying users; and
the visual attribute is applied to the results of the modification operations performed by each IMS modifying user.

5. The method of claim 1, wherein
the modified digital content is stored in a repository for retrieval by the plurality of IMS users.

6. The method of claim 1, wherein
the modified digital content is copied from the shared workspace into the first window.

7. A system comprising:
a processor;
a data bus coupled to the processor; and
a computer-usable medium embodying computer program code, the computer-usable medium being coupled to the data bus, the computer program code providing synchronous, real-time collaboration in an instant messaging system (IMS) and comprising instructions executable by the processor and configured for:
establishing an IMS session between a plurality of IMS users, the IMS session being presented to the plurality of IMS users in a first window of an IMS user interface (UI);
generating a shared workspace, accessible by the plurality of the IMS users through a second window of the IMS UI;
enabling digital content to be entered into the shared workspace through the second window by an IMS initiating user; and
enabling modification operations on the digital content to be performed via the second window, the modification operations being synchronously performable by a plurality of IMS modifying users.

8. The system of claim 7, wherein the shared workspace resides in the IMS.

9. The system of claim 7, wherein
the modification operations performed by a first IMS modifying user block a second IMS modifying user from performing modification operations until the first IMS modifying user relinquishes control of the modification operations to the second IMS modifying user.

10. The system of claim 7, wherein
a visual attribute is assigned to each of the plurality of IMS modifying users, and
the visual attribute is applied to the results of the modification operations performed by each IMS modifying user.

11. The system of claim 7, wherein
the modified digital content is stored in a repository for retrieval by the plurality of IMS users.

12. The system of claim 7, wherein
the modified digital content is copied from the shared workspace into the first window.

13. A computer-usable medium embodying computer program code, the computer program code comprising computer executable instructions configured for:
establishing an IMS session between a plurality of IMS users, the IMS session being presented to the plurality of IMS users in a first window of an IMS user interface (UI);
generating a shared workspace, accessible by the plurality of the IMS users through a second window of the IMS UI;
enabling digital content to be entered into the shared workspace through the second window by an IMS initiating user; and
enabling modification operations on the digital content to be performed via the second window, the modification operations being synchronously performable by a plurality of IMS modifying users.

14. The computer usable medium of claim 13, wherein
the shared workspace resides in the IMS.

15. The computer usable medium of claim 13, wherein
the modification operations performed by a first IMS modifying user block a second IMS modifying user from performing modification operations until the first IMS modifying user relinquishes control of the modification operations to the second IMS modifying user.

16. The computer usable medium of claim 13, wherein
a visual attribute is assigned to each of the plurality of IMS modifying users, and
the visual attribute is applied to the results of the modification operations performed by each IMS modifying user.

17. The computer usable medium of claim 13, wherein
the modified digital content is stored in a predetermined repository for retrieval by the plurality of IMS users.

18. The computer usable medium of claim 13, wherein
the modified digital content is copied from the shared workspace into the first window.

19. The computer usable medium of claim 13, wherein
the computer executable instructions are deployable to a client computer from a server at a remote location.

20. The computer usable medium of claim 13, wherein
the computer executable instructions are provided by a service provider to a customer on an on-demand basis.
